(19) United States
(12) Patent Application Publication
(10) Pub. No.: US 2024/0227030 A1
(43) Pub. Date: Jul. 11, 2024

(54) WIPER INSERT AND TOOL WITH THE SAME

(71) Applicant: BEIJING WORLDIA DIAMOND TOOLS CO., LTD., Chaoyang District, Beijing (CN)

(72) Inventors: Zongchao ZHANG, Beijing (CN); Shuo HAN, Beijing (CN); Jianguang YANG, Beijing (CN); Jinbao HUANG, Beijing (CN); Hongyan TANG, Beijing (CN); Yanyan WANG, Beijing (CN)

(21) Appl. No.: 18/011,266

(22) PCT Filed: Nov. 3, 2022
(86) PCT No.: PCT/CN2022/129506

§ 371 Date: Dec. 21, 2023

(30) Foreign Application Priority Data
Jun. 16, 2022 (CN) 202210282265.9
Jun. 16, 2022 (CN) 202221504761.7

(51) Int. Cl. B23B 27/16

(52) U.S. Cl. CPC B23B 27/1611

(57) ABSTRACT

A wiper insert and a tool with the same. The wiper insert includes a tool body, and the tool body includes a cutting part which is used to cut a workpiece. The cutting part includes a plurality of wipers. Adjacent wipers are connected by a transition surface, and the minor cutting edge angles of the plurality of wipers are set differently. With the technical solution of the present application, the problem in the prior art that the wiper inserts lose their wiping effects when they are mounted on different tool holders is solved effectively.

This application claims priority to the Application No. 202210682265.9, titled “A WIPER INSERT AND A TOOL WITH THE SAME”, filed with the China National Intellectual Property Administration on Jun. 16, 2022, and priority to the Application No. 202221504761.7, titled “A WIPER INSERT AND A TOOL WITH THE SAME”, filed with the China National Intellectual Property Administration on Jun. 16, 2022 which are incorporated herein by references in their entirety.

### FIELD

The disclosure relates to the technical field of tool designs, in particular to a wiper insert and a tool with the same.

### BACKGROUND

A wiper is a kind of tool structure. In terms of structure, the wiper mainly plays the role of increasing the impact resistance of the tool tip and reducing the surface roughness value of the workpiece.

A wiper tool squeezes or scrapes the processed surface by reducing the attachment angle (i.e., the minor cutting edge angle, usually 0-3°) between the cutting edge of the tool and the processed surface, so as to improve the processing quality of the processed surface. In the prior art, there is only one or two symmetrical wipers on one tip of the tool, so that a piece of wiper tool needs to be mounted on a specific tool holder and forms a specific angle during processing to function. The same type of inserts can correspond to several cutting edge angles as well as right-handed and left-handed tool holders. After the wiper tool's tool holder was replaced with other ones, the wiper of the tool will fail. When the wiper processes different parts such as outer circle, end face or profiling simultaneously, it will also fail.

For the problem in the prior art that the wiper insert loses the wiping effect when it is mounted on different tool holders, no effective solution has been proposed so far.

### SUMMARY

The main object of the present disclosure is to provide a wiper insert and a tool with the same, so as to solve the problem in the prior art that the wiper insert loses the wiping effect when it is mounted on different tool holders.

In order to achieve the above object, according to one aspect of the present disclosure, a wiper insert is provided, including: a tool body, the tool body includes a cutting part which is used to cut a workpiece, the cutting part includes a plurality of wipers, wherein adjacent wipers are connected by a transition surface, and the minor cutting edge angles of the plurality of wipers are set differently.

Further, the plurality of wipers are provided in one-to-one correspondence with a plurality of tool holders having different preset major cutting edge angles, so that when the tool body is connected with any one of the plurality of tool holders, there are wiping operations on the workpiece performed by the wiper corresponding to the tool holder.

Further, a mounting hole is provided in the middle of the wiper insert, the radial cross-section of the wiper insert along the mounting hole is polygonal, and a cutting part is provided on at least one apex corner of the polygon.

Further, there are two cutting parts, and the two cutting parts are disposed symmetrically at 180° with respect to the central axis along the mounting hole.

Further, the adjacent wiper inserts are connected by a transition arc surface or a transition plane, and when the adjacent wipers are connected by a transition arc surface, the transition arc surface is tangent to the wiper, and the first arc diameter of the transition arc surface is R1, wherein 0.1 mm≤R1≤2 mm.

Further, the wiper is in the shape of an arc or a line, and when the wiper insert is in the shape of an arc, the second arc diameters of each wiper are set identically, the widths of each wiper are set identically, and the second arc diameter is R2 and the width is L1, wherein 0.4 mm≤R2≤ 10 mm and 0.05 mm≤ L1≤1 mm.

Further, a plurality of wipers are evenly spaced along the circumferential direction of the cutting part.

Further, the wiper insert is made of one of alloy, ceramic, polycrystalline cubic boron nitride, and polycrystalline diamond.

According to another aspect of the present disclosure, a tool is provided, including a wiper insert, and the wiper insert is the wiper insert described hereinabove.

By applying the technical solution of the present disclosure, the tool body includes a cutting part, and the cutting part includes a plurality of wipers, the minor cutting edge angles of which are set differently. By setting a plurality of wiper inserts with different minor cutting edge angles, when the wiper insert is mounted on a variety of different tool holders or workpieces of different shapes are processed, there is a suitable wiper to wipe the processed surface, the surface roughness of the processed workpiece is thus improved. With the technical solution of the present application, the problem in the prior art that the wiper inserts lose their wiping effects when they are mounted on different tool holders is solved effectively.

### DRAWINGS

The accompanying drawings constituting a part of this application are intended to provide a further understanding of the present disclosure, and the illustrative embodiments of the present disclosure and their descriptions are used to explain the disclosure and do not constitute improper limitations to the disclosure, wherein:

FIG. 1 shows a schematic structural view of a first embodiment of a wiper insert according to the present disclosure;

FIG. 2 shows the enlarged schematic structural view of part A in FIG. 1;

FIG. 3 shows a schematic structural view of a second embodiment of a wiper insert according to the present disclosure;

FIG. 4 shows the enlarged schematic structural view of part B in FIG. 3;

FIG. 5 shows a schematic structural view of a third embodiment of a wiper insert according to the present disclosure;

FIG. 6 shows the enlarged schematic structural view of part C in FIG. 5;

FIG. 7 shows a schematic structural view of a fifth embodiment of a wiper insert according to the present disclosure;

FIG. 8 shows a schematic structural view of the sixth embodiment of the wiper insert according to the present disclosure;

FIG. 9 shows a schematic structural view of a seventh embodiment of a wiper insert according to the present disclosure; and

FIG. 10 shows a schematic structural view of a conventional wiper insert.

### LIST OF THE REFERENCE NUMERALS IN THE DRAWINGS

10 Tool body
20 Cutting part
21 Wiper
30 Transition surface
31 Transition arc surface
40 Mounting hole
50 Surface to be processed

### DETAILED DESCRIPTION

It should be noted that the embodiments in the present application and the features in the embodiments can be combined with each other without creating conflict. The present disclosure will be described in detail below with reference to the accompanying drawings and in conjunction with the embodiments.

It should be noted that the terminologies used here are only for the purpose of describing specific embodiments, and is not intended to limit the exemplary embodiments according to the present application. As used herein, unless the context clearly dictates otherwise, the singular form is also intended to include the plural, and it should also be understood that when the terms “comprising” and/or “including” are used in this specification, they are indicative of the presence of features, steps, operations, device, components and/or combinations thereof.

It should be noted that the terms “first”, “second”, etc. in the description and claims of the present application and the above-mentioned drawings are used to distinguish similar objects, but not necessarily used to describe a specific order or sequence. It is to be understood that the terms thus used are interchangeable where appropriate, such that the embodiments of the application described herein are, for example, capable of embodying in sequences other than those illustrated or described herein. Furthermore, the terms “comprising” and “having”, as well as any variations thereof, are intended to cover a non-exclusive inclusion, for example, a process, method, system, product or apparatus comprising a sequence of steps or elements is not necessarily limited to those explicitly listed, but may include other steps or elements not explicitly listed or inherent to the process, method, product or apparatus.

Now, exemplary embodiments according to the present application will be described in more detail with reference to the accompanying drawings. These example embodiments may, however, be embodied in a variety of different forms and should not be construed as limited to only the embodiments set forth herein. It should be understood that these embodiments are provided so that the disclosure of the present application will be thorough and complete and will fully convey the concept of these exemplary embodiments to those of ordinary skill in the art. In the drawings, for purpose of clarity, the thicknesses of layers and regions may be enlarged, and the same reference numerals are used to designate the same device, and thus their descriptions will be omitted.

According to the calculation formula of surface roughness, reducing the feed rate or increasing the radius of the tip of the tool can both reduce the value of the surface roughness, but the former will reduce the production efficiency, while the latter will increase the cutting force. By reducing the minor cutting edge angle, the value of the surface roughness can be reduced without reducing the feed rate. The design ideas of the wiper inserts consist of adjusting the geometry of the tip of the tool within the maximum allowable radius tolerance of the tip of a standard insert in order that it approximates an elliptical shape. In fact, when the tool is processed at the feed rate F per revolution, a corrugated processed surface will be formed due to the formation of the tip of the tool. When the wiper is added (the arc diameter of which is larger than the diameter of the arc diameter of the tip of the tool), even though the processing is still performed according to the feed rate F, the roughness of the processed surface will decrease due to the larger arc.

On the basis of this, the existing wiper inserts are only provided with a wiper corresponding to the tool holder on one side of the primary cutting edge. When the wiper insert is mounted on other tool holders corresponding to different major cutting edge angles, the wiper insert cannot contact with the processed surface of the workpiece, and then cannot realize the wiping effect.

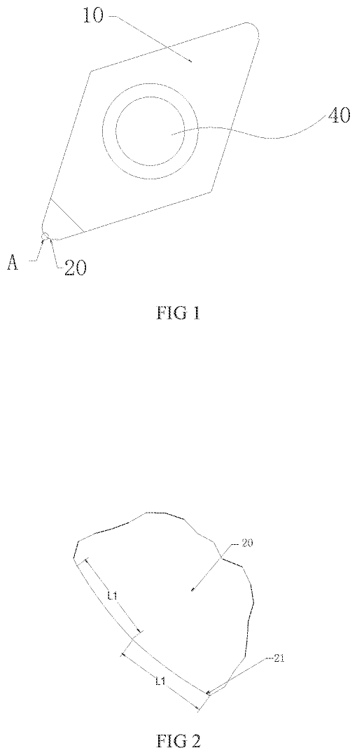

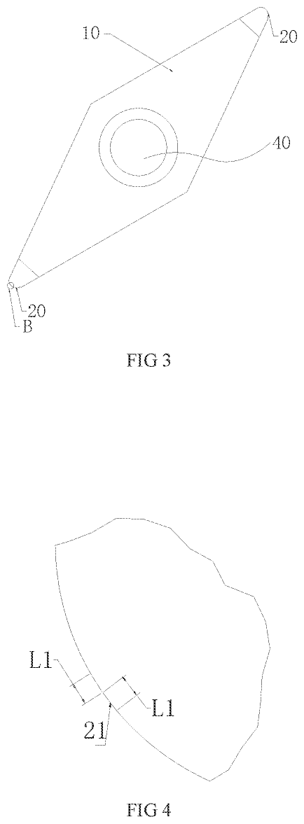

As shown in FIGS. 1 to 9, according to a specific embodiment of the present application, a wiper insert is provided.

The wiper insert includes a tool body 10. The tool body 10 includes a cutting part 20. The cutting part 20 is used for cutting a workpiece. The cutting part 20 includes a plurality of wipers 21. Adjacent wipers 21 are connected by a transition surface 30. The minor cutting edge angles of the plurality of wipers 21 are set differently.

By applying the technical solution of the present disclosure, the tool body includes a cutting part, and the cutting part 20 includes a plurality of wipers 21, the minor cutting edge angles of which are set differently. By setting a plurality of wipers 21 with different minor cutting edge angles, when the wiper insert is mounted on a variety of different tool holders or workpieces of different shapes are processed, there is a suitable wiper 21 to wipe the processed surface, and the surface roughness of the processed workpiece is thus improved. With the technical solution of the present application, the problem in the prior art that the wiper inserts lose their wiping effects when they are mounted on different tool holders. With the technical solution of the present application, a new multi-stage wiping tool is provided, which is suitable for cutting and machining with different major cutting edge angles, extends the range of application of wiper 21 insert, and reduces the cost to use of wiper insert.

It should be noted that the major cutting edge angle of the tool is the angle between the cutting edge in the base surface and the feed direction, and the minor cutting edge angle is the angle between the negative cutting edge in the base surface and the opposite direction of the feed direction. The major cutting edge angle and the minor cutting edge angle of the tool have a corresponding relationship, wherein the major cutting edge angle+the minor cutting edge angle+the angle of the tip of the tool=180°. The major cutting edge angle of the tool is mainly related to the tool model, the tool holder and the processing position. Cutter holders are traditionally distinguished according to the major cutting edge angle. Wherein, when the feed direction changes, the actual major and minor cutting edge angles of the tool will also change. For example, when the 93° primary cutter holder is fed to the left, the actual major cutting edge angle is 93° and the minor cutting edge angle is 32°; and when it is fed upward, the actual major cutting edge angle will become 122°, and the minor cutting edge angle will be 3°.

Therefore, when the tool is mounted on different tool holders or when workpieces of different shapes are processed, the phenomenon of wiper failure is very likely to occur, which affects the surface roughness of the product. How to avoid such phenomena to improve the processing accuracy of the product has become a technical problem that needs to be solved urgently in the industry. With the technical solution of the present application, the tool can realize multi-stage wiping, and there is no need to replace the tool while the effect of the wiper is ensured, which greatly saves the processing cost and improves the processing quality at the same time.

In an optional embodiment, the cutting part 20 further includes a cutting edge, and the plurality of wipers 21 are all located on the same side of the cutting edge. During processing, the cutting edge cuts the workpiece by a margin, and then the wiper 21 finishes the cut surface to improve the smoothness of the workpiece.

In an optional embodiment, the radial cross-section of the tool body 10 along the mounting hole is a parallelogram, and cutting units are disposed symmetrically at the apex corners in the upper surface that correspond to the longer diagonal of the parallelogram. Each of the cutting units includes a primary cutting edge formed by the long side of the apex angle, and a secondary cutting edge is formed by the short side of the apex angle. The wiper 21 is disposed between the primary cutting edge and the secondary cutting edge, and the minor cutting edge angle of the wiper 21 is set correspondingly to the major cutting edge angles of a variety of tool holders to be used. The wiper 21 of the turning insert refers to the edge of the insert that contacts with the processing plane, and the wiper 21 of the turning insert refers to the edge of the insert that contacts with the outer circular surface or the inner circular surface of the processing surface. The effect of the wiper 21 is similar to that of the secondary cutting edge. The cutting edge angle of the wiper is generally 0° to 3°, and the length of the wiper is about 2 times of the cutting amount. The wiper 21 can reduce the roughness of the processing surface and improve the processing quality.

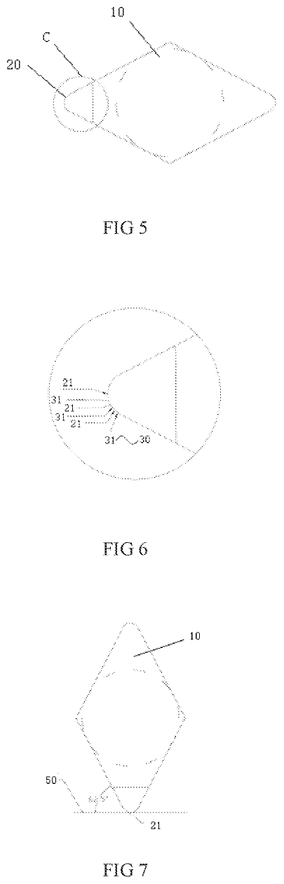

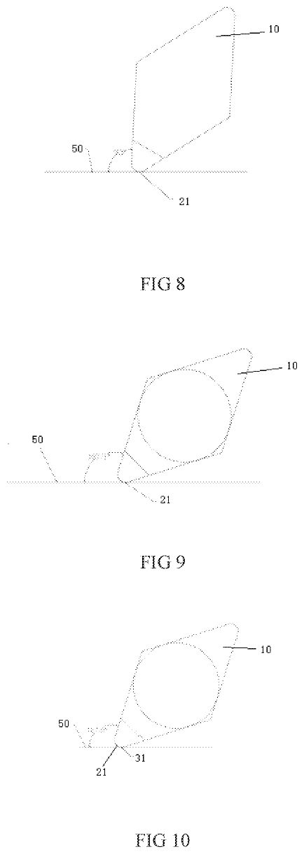

Further, a plurality of wipers 21 are provided in one-to-one correspondence with a plurality of tool holders having different preset major cutting edge angles, so that when the tool body 10 is connected with any of the plurality of tool holders, there is a wiper 21 corresponding to the tool holder to perform wiping operation on the workpiece. By way of example, the commonly used tool holders for D-type tools (the included angle is 55°) mainly include three types: 93°, 107.5° and 62.5°. As shown in FIGS. 5 and 6, it is a wiper insert that can adapt to the above three angles at the same time. When the major cutting edge angle corresponding to the tool holder connected with the tool body 10 is 62.5°, as shown in FIG. 7, the first one among the plurality of wipers 21 is in the working position. When the major cutting edge angle corresponding to the tool holder connected with the tool body 10 is 93°, as shown in FIG. 8, the second one among the plurality of wipers 21 is in the working position. When the major cutting edge angle corresponding to the tool holder connected with the tool body 10 is 107.5°, as shown in FIG. 9, the third one among the plurality of wipers 21 is in the working position. As shown in FIG. 10, the existing wiper insert is a wiper insert corresponding to a tool holder with a 62.5° major cutting edge angle, which can only be applied to the corresponding cutter holder. After the cutter holder (a cutter holder with a major cutting edge angle of 107.5°) of the wiper insert shown in FIG. 10 is replaced, the cutting position in contact with the surface of the workpiece is the transitional arc surface 31, and the wiper 21 cannot function to wipe. With the technical solution of this embodiment, when the wiper 21 is mounted with tool holders corresponding to a plurality of different major cutting edge angles, it is possible for a suitable wiper 21 to function to wipe the processed surface 50 of the workpiece, improving the applicability of the wiper insert.

Specifically, a mounting hole 40 is provided in the middle of the wiper insert. The radial cross-section of the wiper insert along the mounting hole 40 is polygonal, and a cutting part 20 is provided on at least one apex corner of the polygon. The mounting hole 40 is used to secure the wiper insert to the tool holder. Polygons include but are not limited to structures such as quadrilaterals and pentagons, and the cutting part 20 can also be designed according to actual needs.

Preferably, there are two cutting parts 20. The two cutting parts 20 are disposed symmetrically at 180° with respect to the central axis along the mounting hole 40.

Further, adjacent wipers 21 are connected by a transition arc surface 31 or a transition plane. When adjacent wiper 21 are connected by a transition arc surface 31, the transition arc surface 31 is tangent to the wiper 21, and the first arc diameter of the transition arc surface 31 is R1, wherein 0.1 mm≤ R1≤2 mm.

Further, the shape of the wiper 21 is an arc or a line. When the shape of the wiper 21 is an arc, the second arc diameters of each wiper 21 are set identically, and the widths of each wiper 21 are set identically. The second arc diameter is R2, and the width is L1, wherein 0.4 mm≤ R2≤10 mm and 0.05 mm≤L1≤1 mm. Optionally, the arc is determined according to the major cutting edge angle of the tool or the shape of the workpiece to be processed. The first arc diameter is sized to be smaller than the second arc diameter. In an optional embodiment, the edge of the cutting part 20 is composed of n wipers, and n can be any integer greater than 2. The wiper insert is mounted to the tool holder, and the angle between the cutting portion of the insert and the processed portion of the workpiece is in the range of 0° to 3°.

In an optional embodiment, the edge of the cutting part 20 is composed of a plurality of arc-shaped wipers 21, and the second arc diameters and widths of all the wipers 21 are the same and evenly distributed. The second arc diameter is between 0.4-10 mm, and the width of the wiper is between 0.05-1 mm. The arc of the wiper 21 is connected with the arc of another wiper 21 by a transitional arc and is tangent to each other, and the diameter of the transitional arc is r=0.02 mm. Optionally, the arc of the wiper 21 is connected with the arc of another wiper 21 by a curved surface satisfying a preset functional relation.

In an optional embodiment, the edge of the cutting part 20 is composed of a plurality of arc-shaped wipers 21, and the second arc diameters and widths of the arcs of different wipers 21 are different. The angle of the wiper 21 is sized according to the major cutting edge angle of the tool holder corresponding to the insert and the processing position of the workpiece to be processed, and the insert can be applied to a tool holder with any major cutting edge angle.

In an optional embodiment, the edge of the cutting part 20 is composed of a plurality of arc-shaped wipers 21, and the second arc diameters and widths of the arcs of different wipers 21 are different. Optionally, at least one of the second arc diameters and widths of different wipers 21 is set identically, and the angles of some wipers are designed according to the major cutting edge angle of the corresponding tool holder of the insert, and the wiper insert can be suitable for tool holders with any major cutting edge angle. The rest of the wipers 21 are evenly distributed among the determined wipers 21.

Specifically, the wiper insert includes a top surface and a lower positioning surface disposed oppositely. The width of the edge of the wiper 21 along the direction from the top surface to the lower positioning surface is set to reduce gradually.

Optionally, a plurality of wipers 21 are evenly spaced along the circumferential direction of the cutting part 20. This arrangement can further extend the range of application of the wiper insert and improve the wiping effect on the workpiece.

In order to ensure that the wiper insert has good mechanical strength, the wiper insert is made of one of alloys, ceramics, polycrystalline cubic boron nitride, and polycrystalline diamond.

According to another aspect of the present application, a tool is provided, including a wiper insert, and the wiper insert is the one in the above embodiment. The tool includes a tool holder, and the tool holder is provided with a step for fitting the wiper insert, and a screw hole is provided on the step. When the wiper insert is fitted on the step, the screw hole is coaxial with the mounting hole of the insert, and the insert is securely connected with the tool head via a bolt.

In an optional embodiment, a chip-breaking groove is provided on the top surface of the tool body 10, the chip-breaking groove is disposed close to the wiper 21 and is an arc-shaped groove.

For the convenience of description, spatially relative terms, such as “on . . . ”, “above . . . ”, “on the upper surface of . . . ”, “upper”, etc., may be used herein to describe the spatial positional relationship between one device or feature shown in the figures and other devices or features. It should be understood that the spatially relative terms are intended to encompass different orientations of the device in use or operation in addition to the orientation depicted in the figures. For example, if the device in the figures is turned over, apparatuses described as “above other devices or configurations” or “on other devices or configurations” would then be oriented “below other devices or configurations” or “under other devices or configurations”. Thus, the exemplary term “above” can encompass both an orientation of “above” and “below”. The devices may be oriented differently (rotated 90 degrees or in other orientations) and the spatially relative descriptions used herein is interpreted accordingly.

In addition to the above, it should to be noted that “an embodiment”, “another embodiment”, “embodiments” and the like mentioned in this specification refer to specific features, structures or characteristics are included in at least one embodiment described summarily in this application. The appearance of the same expression in multiple places in the specification does not necessarily refer to the same embodiment. Further, when a specific feature, structure or characteristic is described in connection with any embodiment, it should be claimed that implementing such a feature, structure or characteristic in connection with other embodiments also falls within the scope of the present disclosure.

In the above embodiments, the descriptions of each embodiment have their own emphases, and for parts not described in detail in a certain embodiment, reference may be made to relevant descriptions of other embodiments.

The above descriptions are only preferred embodiments of the present disclosure, and are not intended to limit the present disclosure. For those skilled in the art, the present disclosure can have various modifications and changes. Any modification, equivalent replacement, improvement, etc. made within the spirit and principles of the present disclosure shall be included in the scope of the present disclosure.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A wiper insert, comprising:
a tool body comprising a cutting part which is used to cut a workpiece, wherein the cutting part includes a plurality of wipers, the adjacent wipers are connected by a transition surface, and the minor cutting edge angles of the plurality of wipers are set differently.

2. The wiper insert according to claim 1, wherein the plurality of wipers are provided in one-to-one correspondence with a plurality of tool holders having different preset major cutting edge angles, so that when the tool body is connected with any one of the plurality of tool holders, there are wiping operations on the workpiece performed by the wiper corresponding to the tool holder.

3. The wiper insert according to claim 1, wherein a mounting hole is provided in the middle of the wiper insert, and the radial cross-section of the wiper insert along the mounting hole is polygonal, and the cutting part is provided on at least one apex corner of the polygon.

4. The wiper insert according to claim 3, wherein two cutting parts are provided, and the two cutting parts are disposed symmetrically at 180° with respect to the central axis along the mounting hole.

5. The wiper insert according to claim 1, wherein the adjacent wiper inserts are connected by a transition arc surface or a transition plane, and when the adjacent wipers are connected by a transition arc surface, the transition arc surface is tangent to the wiper, and the first arc diameter of the transition arc surface is R1, wherein 0.1 mm≤R1≤2 mm.

6. The wiper insert according to claim 1, wherein the wiper is in the shape of an arc or a line, and when the wiper is in the shape of an arc, the second arc diameters of each wiper are set identically, the widths of each wiper are set identically, and the second arc diameter is R2 and the width is L1, wherein 0.4 mm≤R2≤10 mm and 0.05 mm≤L1≤1 mm.

7. The wiper insert according to claim 3, wherein the plurality of wipers are evenly spaced along a circumferential direction of the cutting part.

8. The wiper insert according to claim 1, wherein the wiper insert is made of one of alloys, ceramics, polycrystalline cubic boron nitride, and polycrystalline diamond.

9. A tool comprising the wiper insert according to claim 1.
